(19) United States
(12) Patent Application Publication
(10) Pub. No.: US 2026/0153200 A1
(43) Pub. Date: Jun. 4, 2026

(54) NATURAL GAS HANDLING SYSTEM AND METHOD OF USE THEREOF

(71) Applicant: 2091171 Alberta Ltd., Red Deer County (CA)

(72) Inventors: Julie WISEMAN, Red Deer County (CA); Sean WISEMAN, Red Deer County (CA); Henry MUCHIRI, Red Deer County (CA); Jacob SALETSKY, Red Deer County (CA)

(21) Appl. No.: 19/402,330

(22) Filed: Nov. 26, 2025

Related U.S. Application Data
(60) Provisional application No. 63/726,365, filed on Nov. 29, 2024.

(51) Int. Cl. F17D 3/10; F17C 5/06; F23G 7/06

(52) U.S. Cl. CPC F17D 3/10; F17C 5/06; F23G 7/06; F17C 2221/033; F17C 2227/0157; F17C 2250/0636; F17C 2265/068; F23G 2209/141

(57) ABSTRACT

A system is provided for handling blowdown gas evacuated from a segment of pipeline. The system includes: one or more compressor units for receiving blowdown gas from the segment of pipeline; an incinerator unit for receiving blowdown gas from the one or more compressor units; a flow control diverter valve; one or more sensors associated with each of the one or more compressor units, the one or more incinerator units, one or more pressure vessels and interconnected piping to collect operational data and blowdown gas data; and a processor in communication with the one or more sensors for receiving the operational data and the blowdown gas data, said processor comprising algorithms for determining, one or more switchover pressures at which blowdown gas should be re-directed from a recompression operation to an incineration operation. A method is further provided for handling blowdown gas evacuated from a segment of a pipeline.

### CROSS REFERENCE TO RELATED APPLICATIONS

This application claims the priority benefit of U.S. Provisional Patent Application No. 63/726,365, filed Nov. 29, 2024, which is hereby incorporated herein by reference in its entirety.

### FIELD

The present disclosure relates to a portable unit and method for handling natural gas.

### BACKGROUND

Natural gas is commonly transported and supplied to its final destination via natural gas transmission, distribution or gathering pipelines. These pipelines are fitted with compression stations, along the length of the pipeline to maintain the gas pressure needed for transmission, distribution or gathering. Often, segments of the pipeline between compression stations need to be emptied during a pipeline ‘blowdown’ for various reasons. Pipe blowdowns occur for maintenance, repair, emergency or expansion and construction reasons. These segments can be up to 100 km long.

Pipeline blowdowns, while necessary to ensure safe operation during planned maintenance activities, are measured by volumes of lost product, time required to evacuate large volumes of gas, as well as a significant contribution to emissions.

Conventionally, blowdown natural gas was simply vented out to atmosphere. Currently environmental regulations more commonly require that that at least some of the natural gas be combusted or compressed as an alternate to venting. The major component of natural gas, methane, is a potent greenhouse gas—with a global warming potential approximately 25 times greater than that of carbon dioxide.

Combustion converts the blowdown natural gas to form carbon dioxide and water, and results in a less harmful greenhouse gas, but still produces emissions and will likely be more restricted as environmental regulations tighten. Combustion can include traditional flaring in flare stacks or incineration.

Incineration, also called enclosed combustion or enclosed flare, directs natural gas into an enclosed combustion chamber, achieving a conversion rate of over 99% to carbon dioxide, which is more efficient than traditional flare stacks. However, it is a long process, since incinerators can only handle low pressure gas, and so gas from the pipeline needs to be reduced first, leading to a long emptying time for the pipeline segment; the process can take up to a week, and of course, it leads to product loss since the natural gas is burned and flared and not recoverable.

Compression involves removing the gas via a bypass line and sending it to a compressor unit, for compression to a higher pressure, and then reinjecting the compressed gas into a section of the pipeline downstream of the blowdown segment, or to separate vessels. Compression results in no emissions and saves product, but it takes even longer than incineration. As well, since pressure in the pipeline segment decreases with evacuation, the compressor has to work harder to compress the increasing low-pressure gas it is receiving and may require multiple weeks to handle. As such, there are downsides to both current technologies. Compressors must be compact and mobile while maintaining sufficient flow rates to stay competitive with other methods. Consequently, compression units have a narrower operating pressure range than incinerators, often necessitating additional venting of excess gas and limiting the total effectiveness of the recompression process.

While a number of technologies exist for handling natural gas, there still exists a need for systems and methods that allow pipeline operators flexibility in balancing environmental, operating and production requirements and specifications.

U.S. Pat. No. 11,248,746 relates to a blowdown recovery system for a compressor package, as opposed to a pipeline blowdown. The blowdown recovery system comprises a plurality of valves, wherein one or more valves may be used to capture gas to a suction header, a knockout vessel, or a holding tank which may itself be connected to a mitigation device such as a vapour recovery unit or flare, a vent to atmosphere, or a combination thereof.

The volume of gas, usually methane, to be blowdown from the compressor package is significantly smaller than a pipeline blowdown. The time needed for emptying a compressor package is hence very short, the amount of product flared or vented is very small and there is very little environmental regulation around such small amounts. As such, the need to manage evacuation time, emissions or product loss is minimal to none.

U.S. Pat. No. 11,754,229 teaches processes, apparatuses, and systems for capturing blowdown emissions in natural gas pipelines. The process involves filtering and/or separating blowdown emissions. The filtered and/or separated blowdown products can then be stored in a storage, sent back into the natural gas pipeline at a downstream location, or sent to an adjacent pipeline.

This system teaches a blowdown valve configured to selectively discharge a portion of the gas stream flowing in the natural gas pipeline to compression or to vent/flare. However, there does not appear to be any description of control or decision making about directing the blowdown gas based on any criterial like blowdown pressure, emissions limitations, re-use requirements.

CA 2349349A1 teaches a method and apparatus for evacuating a segment of a natural gas pipeline. The method involves drawing natural gas from the out-of-service segment of pipeline to a storage container and/or to an in-service section of the pipeline, with an evacuator until suction pressure falls below a predetermined level. An inert gas is introduced into the evacuator to purge the evacuator of any remaining natural gas and push the purged natural gas to the storage container/in-service section of the pipeline. This reference does not provide an option for incineration, nor does it discuss customizing or optimizing recompression vs. incineration.

US20230313947 teaches a methane retention system for reducing the amount of natural gas that is vented into the atmosphere during depressurization and maintenance of a natural gas compressor unit. Also provided are a method of depressurizing a natural gas compressor unit and a natural gas system, both of which include the methane retention system. This system is not related to customizing pipeline blowdown based on goals of optimizing time and emissions limits.

U.S. Pat. No. 11,994,124 teaches gas compressions systems, and more particularly a system for compressing recovered fugitive or intentionally released natural gas emissions, from compression equipment such that they can be directly reintroduced into a pressurized natural gas pipeline system. The systems of this reference do not provide means or options for incineration of the gas or means to determine operational data of the various units of the systems or optimizing operations based on blowdown goals.

### SUMMARY

A system is provided for handling blowdown gas evacuated from a segment of pipeline The system includes: one or more compressor units for receiving blowdown gas from the segment of pipeline; an incinerator unit for receiving blowdown gas from any one or more of the segment of pipeline, the one or more compressor units or one or more pressure vessels; a flow control diverter valve for directing blowdown gas from the segment of pipeline or from the one or more compressor units to any one or more of: the incinerator unit, the one or more pressure vessels and a section of the pipeline downstream from the segment to be blown down; interconnected piping between the segment of pipeline, the one or more compressor units, the incinerator unit, the one or more pressure vessels and the flow control valve; one or more sensors associated with each of the one or more compressor units, the one or more incinerator units, the one or more pressure vessels and the interconnected piping to collect operational data and data about the blowdown gas; and a processor in communication with the one or more sensors for receiving the operational data about each of the one or more compressor units, the one or more incinerator units, the one or more pressure vessels and the interconnected piping and the data about the blowdown gas, said processor comprising algorithms for determining, one or more switchover pressures at which blowdown gas should be re-directed from a recompression operation to an incineration operation.

A method is further provided for handling blowdown gas evacuated from a segment of a pipeline. The method includes the steps of: receiving blowdown gas from the segment of pipeline to a compressor unit; recompressing the blowdown gas to increase blowdown gas pressure; receiving the recompressed blowdown gas in any one or more of: an incinerator unit; a pressure vessel or a section of the pipeline downstream from the segment to be blown down; receiving at a processor, data regarding the blowdown gas from the segment of pipeline and data on the operation on each of the compressor unit, the incinerator unit and the pressure vessel.

The processor performs the steps of: determining by one or more algorithms stored in the processor, a switchover pressure at which blowdown gas should be re-directed from a recompression operation to an incineration operation; and directing, by communication from the processor, a flow control diverter valve to re-direct blowdown gas from a recompression operation to an incineration operation at the switchover pressure.

It is to be understood that other aspects of the present disclosure will become readily apparent to those skilled in the art from the following detailed description, wherein various embodiments of the disclosure are shown and described by way of illustration. As will be realized, the disclosure is capable of other and different embodiments and its several details are capable of modification in various other respects, all without departing from the spirit and scope of the present disclosure. Accordingly, the drawings and detailed description are to be regarded as illustrative in nature and not as restrictive.

### BRIEF DESCRIPTION OF THE DRAWINGS

A further, detailed, description of the disclosure, briefly described above, will follow by reference to the following drawings of specific embodiments of the disclosure. The drawings depict only typical embodiments of the disclosure and are therefore not to be considered limiting of its scope. In the drawings:

FIG. 1 is a schematic diagram of a first embodiment of the present system;

FIG. 2 is a schematic diagram of a second embodiment of the present system;

FIG. 3 is a schematic diagram of a third embodiment of the present system; and

FIG. 4 is a logic flow diagram of one embodiment of steps of the present method.

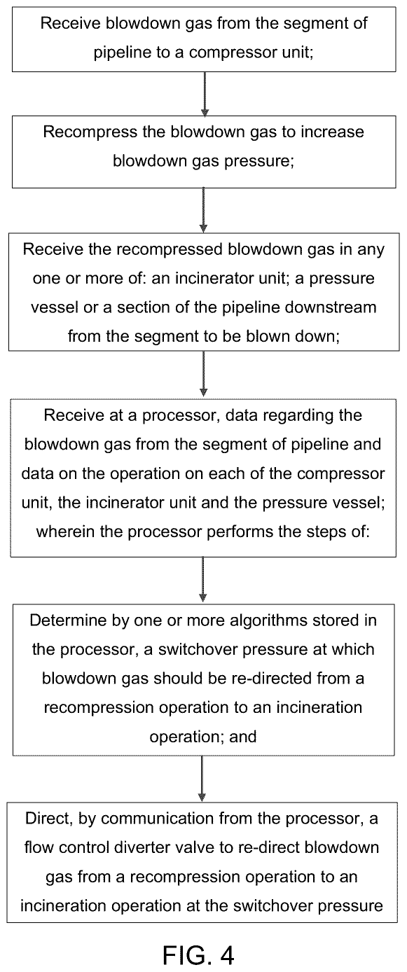

The drawings are not necessarily to scale and in some instances, proportions may have been exaggerated in order to more clearly depict certain features.

### DETAILED DESCRIPTION

The present disclosure provides a portable system that provides venting, incineration or flaring, and recompression options to a pipeline company in a blowdown event, and methods for optimizing how blowdown gas is processed based on key factors of time available/acceptable for blowdown, goals and requirements for emissions reduction, and potential value of blowdown product. Emissions reduction targets are typically measured as a percentage less of emissions as compared to direct venting.

The present disclosure also provides methods by which an optimal balance can be reached between the key factors. The present method serves to optimize compression, incineration or flaring, and venting operations based on real time blowdown line pressure, taking into account factors including volume flow rate, mass flow rate, pressure gradient, and compression power input for compression, over a given time step.

As stated earlier, there are three factors to consider during a planned blowdown: evacuation time, emissions, and loss of product. By way of example, a 15-mile (24 km), 16″ (0.4064 m) natural gas transmission line operating at 800 psi (5.5 MPa) with a 4″ (0.1023 m) diameter blowdown vent would have the following blowdown characteristics if the gas were simply to be vented:

| | | |
|---|---|---|
| Time to Evacuate | 178 | minutes |
| Methane Vented | 148 | metric tons |
| Greenhouse Gas Equivalent | 3,700 | metric tons (CO₂e) |

Through engineered analysis and operational experience, the present blowdown system can optimize blowdown gas handling to reduce emissions, maintain acceptable evacuation times, and maximize product recovery. The system takes advantage of examining how compressors and incineration systems achieve optimal efficiency at different gas pressure levels. The present system is designed to enable switching between incineration and recompression based on a predetermined or real-time determined switchover pressure, to leverage the benefits of both technologies. The switchover pressure represents a pressure at which optimization of the blowdown operation transitions from recompression to incineration, or from either recompression or incineration to simply venting, depending to operational conditions. Switchover pressure might be predetermined from engineering analysis and/or can be determined or changed at site in real-time, taking further into account such factors as weather, labour availability, and other factors. While the disclosure herein refers to incineration particularly, it would be understood that incineration could be replaced with flaring, depending on operations and infrastructure at different sites.

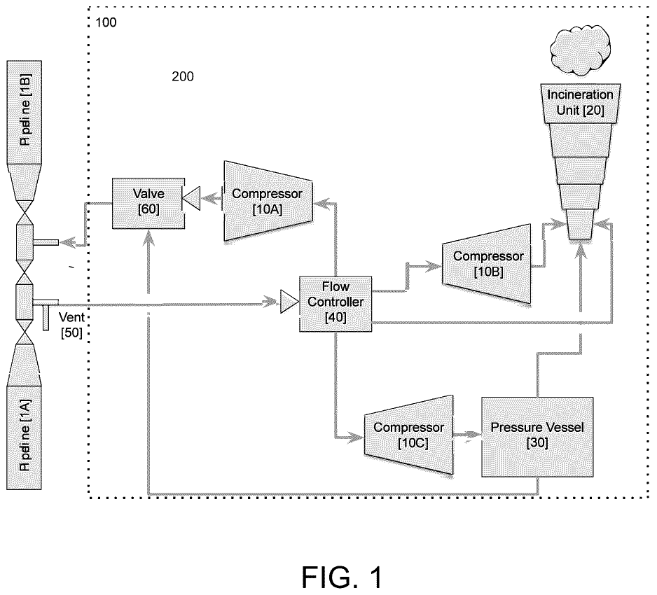

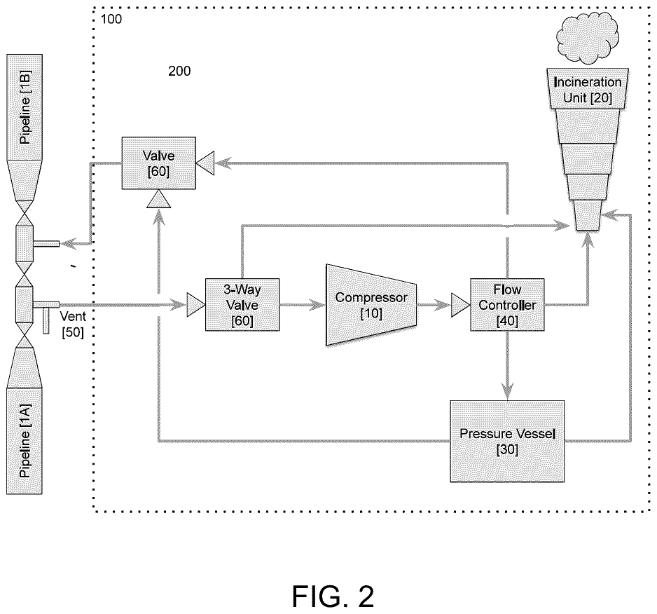

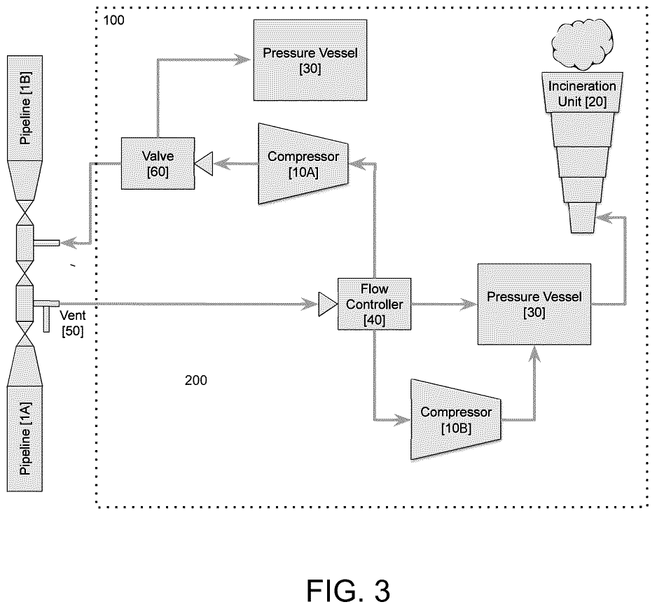

With reference to FIGS. 1, 2 and 3, the present system 100 draws blowdown gas from an upstream end 1A of a pipeline 1 and is connectable to return at least a portion of the blowdown gas to a downstream end 1B of the pipeline. At least a portion of the blowdown gas from the upstream end 1A of the pipeline 1 can also be vented via vent line 50. The system 100 comprises one or more compressors 10, 10A, 10B and or 10C and one or more incinerators 20, each of which can be fed blowdown gas from the upstream end 1A of the pipeline. In the embodiment of FIG. 2, connection from the compressor 10 to various other downstream destinations and processes can be directed via flow controller/diverter valve 40. In the embodiment of FIG. 1, flow controller 40 receives the upstream gas 1A and directs to one or more compressors 10A, 10B, 10C, where gas is compressed and then directed to one or more downstream units. In FIG. 3, gas may also be directed directly from flow controller 40 to a pressure vessel.

In some embodiments a first compressor 10A may have a larger capacity and larger compression ability to receive higher pressure blowdown gas at the initial stages of the blowdown event. The first compressor 10A will have an optimum pressure band of operation. As blowdown gas pressure decreases, it may be optimal to switch operations from the first compressor to a smaller secondary compressor 10B with a lower optimal pressure band, to boost pressure of the blowdown gas.

The system 100 may also be connectable from the compressor 10 to one or more pressure vessels 30. In one embodiment of a present method, blowdown gas from the beginning of a blowdown event, when blowdown gas pressure is highest, can be compressed in compressor 10 and stored in the pressure vessel 30. This embodiment of the method and system 100 may be utilized when it is desirable to utilize or sell a portion of the blowdown gas rather than re-introduce it into the downstream end 1B of the pipeline 1. The compressed blowdown gas of the pressure vessel 30 can be stored as compressed natural gas (CNG), offering a marketable product with diverse applications. This capability provides a viable alternative or complement to traditional recompression methods.

Moreover, the pressure vessel 30 can be integrated at various stages within the system 100 to optimize the operational efficiency of both the compressor 10 and the incinerator 20. The pressure vessel 30 can be utilized to extend the length of time that compressor 10 and incinerator 20 can operate at optimum pressures and maintain peak performance across a wider range of conditions. Particularly, pressurized gas in the pressure vessel 30 can be directed to the incinerator 20 or to the compressor 10 to boost gas pressure to these units and extend their optimal operating pressure. In such embodiments, the pressure in the pressure vessel 30 can be set to an optimum feed pressure to the incinerator 20 or to the compressor 10.

The present system 100 can preferably be mounted on one or more skids, a platform or a trailer and transported out to the site for use.

The present system 100 and methods provide increased flexibility for pipeline blowdown events, accommodating various constraints such as evacuation time, emission reduction, or product recovery. The system 100 may also utilize process control mechanisms, including flow control and diverter valve 40 programmed to switch flow between the recompression unit 10 and the incinerator 20 at the designated switchover pressure.

In the method of the present disclosure, the switchover pressure at which to switch from recompression to incineration is first determined by simulating blowdown events to solely venting, solely recompression and solely incineration and solving iteratively to determine factors including volume flow rate, mass flow rate, pressure gradient, and compression power input required.

In a solely incineration blowdown process, volume flow rates with respect to line pressure are relatively linear until pressure drops to near-atmospheric. Below approximately 3 psi, the efficiency of the incinerator 20 decreases significantly, resulting in a significant increase in evacuation time for the remaining blowdown gas within the pipeline segment. To bring the pipeline back into operation sooner, oftentimes the incinerator 20 is disconnected and the remainder of the blowdown gas is vented. Due to the low line pressure, however, the contribution of this vented gas to the overall emissions is minimal.

The present system 100 can be customized for particular pipeline segment capacities, operation and blowdown procedures, and the equipment can be sized based on a particular pipeline operator's goals for emissions, blowdown time limits, and product repurposing. Alternatively, the system 100 can be built and sized more generically to fit most blowdown needs. The system 100 is built with all equipment lines and valving on a portable skid unit that can be transported to different segments of pipeline for blowdown procedures.

Importantly, the system 100 includes a processor 200 and computational network (not shown) which can monitor data including pressure decay in the segment of the pipeline to be blown down, changes in blowdown gas flowrate and mass of blowdown gas out of the pipeline segment, as well as emissions amounts and rates, compressor working rates, mass and volume of gas being directed to each of the incinerator, pressure vessels or the downstream section of the pipeline, etc. Sensors provided on the compressor unit 10, incinerator unit 20, piping and valving of the system 100 collect such data and transmits it to the processor 200.

The processor 200 can also be input with blowdown event goals of the operator, namely blowdown time limits, emissions limits, and repurposing goals. With sensor data and the blowdown event goals, the processor 200 determines via algorithms within the processor 200, the switchover pressures, optimum blowdown gas distribution, and operational duration of recompression vs. incineration vs. venting operations.

The processor 200 can be located in a traditional computing device on-site of the present skid system 100 or the processor 200 can be located in a central location that is remote from the system, but which can communicate with the system via any number of communication means, including over the internet. In such cases, the system includes a receiver for receiving information from the central processor 200. Data about the blowdown event, and about operations of the various equipment of the system can be accessed at the skid system or can also be accessed via a remote portal and viewable on such devices as personal computers, laptops, tablets, and smart phones. Such data importantly includes calculated and determined switchover pressures to optimize incineration and recompression operations.

The present system together with the algorithms of the processor 200 of the present system serve to deliver a customizable blowdown event to meet operational goals with respect to the blowdown gas, and timing and serves to optimize operations to meet these goals.

In one embodiment, optionally an on-site an evacuation vessel (not shown) may be used to first knock out liquids from the blowdown gas and create a vacuum condition aimed to increase the pressure gradient between the pipeline segment to be blown down, and the system 100. The greater pressure differential created by the evacuation vessel increases mass flow rate, to both decrease recompression requirements and allow for larger-sized incineration units.

As pressure of the blowdown gas decreases, the increased time required for incineration and/or recompression operations can be calculated. Such increased time to either incinerate or recompress can be compared to the quantity of emissions reduced by either incinerating or recompressing that shrinking amount of blowdown gas as pressure decreases. From emissions reductions data, time required for incineration or recompression data and overall time restraints or goals of the operator, the processor 200 can determine switchover pressure to switch from recompression and/or incineration to simply venting.

The present system 100 includes the needed process control, including diverter valve 40 programmed to switch the flow between the recompression unit and the incinerator at switchover pressures or as directed by the processor 200. Secondary valves 60 may also be controlled by the processor 200 to direct blowdown gas to, for example, directly to the incinerator unit 20 without compression.

Depending on approach, communication via the processor 200 between the recompression unit 10, diverter valve 40, incinerator 20 and pressure vessel 30 ensures that; a) the operating pressure is optimized for recompression and incineration, and b) the diverter valve 40 directs flow to from the recompression unit 10 to the incinerator 20 upon changes in pressure and flow.

The recompression unit 10 on the present system 100 can also be sized to provide further options for the recompressed gas, namely the recompression unit 10 can be sized to generated compressed natural gas (CNG) or liquid natural gas (LNG) for uses and destinations other than just reinjection downstream into the pipeline.

These examples are provided for the purposes of explanation, and not of limitation, of those principles and of the disclosure in its various aspects.

Example #1: the priority in this scenario is emission-reduction over all other factors, and no venting at all is permitted.
1. The pipe segment is isolated from the main line and prepared for blowdown.
2. Gas is directed towards a first Compressor where it will be recompressed back into the pipeline.
3. The gas is recompressed until the pipe segment pressure reaches 120 psig, whereby 80% of the blowdown gas by mass is recompressed and re-injected into a downstream section of the pipeline. This will take approximately 26.1 hours.
4. Blowdown simulation data shows that for this particular blowdown scenario; 120 psig is the switchover pressure at which recompression is no longer optimized or maximized. At this switchover pressure, gas is routed to the incineration, whereby 18% of the gas by mass is incinerated, which takes approximately 14.8 hours. The final pipe segment pressure is approximately 0.9 psi.
5. Blowdown simulation data shows that for the particular blowdown scenario; 0.9 psi is the switchover pressure at which simply directing blowdown gas to the incinerator unit is no longer optimized or maximized. At this second switchover pressure, gas is first routed to a second, optionally smaller capacity, Compressor, where it is boosted to 3 psi and then directed to the incineration unit.

Since, at very low pressures, emissions resulting from inefficiencies of the incineration unit approaches emissions levels of simply venting the gas, boosting the pressure of the remaining blowdown gas before incineration allows the remaining 2% of blowdown gas to be incinerated efficiently and to avoid being directly vented.

| | | |
|---|---|---|
| Time to Evacuate (Recompression) | 26.1 | hours |
| Time to Evacuate (Including Incineration) | 40.9 | hours |
| CO₂e Emissions (Fuel Consumed in Compressor | 14 | metric tons |
| operation) | | |
| CO₂e Emissions (Combustion) | 235 | metric tons |

Time vs. Pressure Decay and Time vs. Volume Evacuated for Example #1 are plotted below.

Example #2: the priority in this scenario is emission-reduction within reason, and secondly evacuation time.
1. The pipe segment is isolated from the main line and prepared for blowdown.
2. Blowdown gas is directed towards the compressor where it is recompressed and directed back into a downstream side of the pipeline.
3. The gas is recompressed until the line pressure reaches 120 psig, whereby 80% of the blowdown gas by mass is recompressed and re-injected into a downstream section of the pipeline. This will take approximately 26.1 hours.
4. Blowdown simulation data shows that for this particular blowdown scenario; 120 psig is the switchover pressure at which recompression is no longer optimized or maximized. At this switchover pressure, blowdown gas is then routed to the incineration unit, whereby 17% of the gas is incinerated for approximately 12 hours. The final pipeline segment pressure is approximately 3 psi.
5. The remaining 3% of gas is vented, as the efficiency of the incineration unit decreases significantly below 3 psi.

| | | |
|---|---|---|
| Time to Evacuate (Recompression) | 26.1 | hours |
| Time to Evacuate (Including Incineration) | 38.1 | hours |
| Time to Evacuate (Including Venting) | 38.4 | hours |
| CO₂e Emissions (Fuel Consumed in Compressor | 14 | metric tons |
| operation) | | |
| CO₂e Emissions (Combustion) | 231 | metric tons |
| CO₂e Emissions (Venting) | 307 | metric tons |

Time vs. Pressure Decay and Time vs. Volume Evacuated for Example #2 are plotted below.

Example #3: the priority in this scenario is to repurpose a portion of the gas from a blowdown event to produce 5 tanker trucks of CNG, in addition, and to minimize emissions within reason.
1. The pipe segment is isolated from the main line and prepared for blowdown.
2. Blowdown gas is directed to the compressor and compressed to 4,500 psig.
3. In this scenario, the pressure vessel is a transport vessel, and more particularly a tanker truck with a volume of approximately 17.53 m³. The tanker truck is coupled to the outlet of the compressor to receive the pressurized gas.
4. Recompression continues until approximately 3,800 kg of gas is evacuated, to fill the pressure vessel. Steps #1 through #3 are repeated for each of the tank trucks. Once all five tanker trucks are filled, the line pressure in the pipe segment is 577 psig, and 4% of the blowdown gas by mass has been evacuated.

In this scenario, the desired number of tank trucks of CNG and the respective volume of those tank trucks determines the first switchover pressure 577 psig of. Assuming 45 minutes is required to decouple and recouple a new tanker truck, upon the departure of the last tanker truck, the process takes approximately 5.3 hours.
5. At the first switchover pressure, blowdown gas is directed from the compressor into a downstream section of the pipeline rather than into a pressure vessel. The blowdown gas is recompressed through the Compressor only until the line pressure in the pipe segment to be blown down reaches 120 psig, whereby 75% of the blowdown gas by mass is re-injected into the pipeline. This can take approximately 24.8 hours.
6. Blowdown simulation data provides that for this particular blowdown scenario; 120 psig is the switchover pressure at which recompression is no longer optimized or maximized. At this second switchover pressure, gas is routed to the incineration unit whereby 17% of the blowdown gas by mass is incinerated. The final line pressure is approximately 3 psi, and this step takes approximately 12 hours,
7. The remaining 3% of gas is vented, as the efficiency of the incineration unit below 3 psi creates emissions levels on par with simply venting.

| | | |
|---|---|---|
| Time to Evacuate (Recompression to Transport | 5.3 | hours |
| Vessel) | | |
| Time to Evacuate (Including Recompression to | 30.1 | hours |
| Pipeline) | | |
| Time to Evacuate (Including Incineration) | 42.1 | hours |
| Time to Evacuate (Including Venting) | 42.4 | hours |
| CO₂e Emissions (Transport Vessel Recompression | 2 | metric tons |
| Fuel Consumption) | | |
| CO₂e Emissions (Pipeline Recompression Fuel | 13 | metric tons |
| Consumption) | | |
| CO₂e Emissions (Combustion) | 231 | metric tons |
| CO₂e Emissions (Venting) | 307 | metric tons |

Time vs. Pressure Decay and Time vs. Volume Evacuated for Example #3 are plotted below.

The previous description of the disclosed embodiments is provided to enable any person skilled in the art to make or use the present disclosure. Various modifications to those embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the full scope consistent with the claims, wherein reference to an element in the singular, such as by use of the article “a” or “an” is not intended to mean “one and only one” unless specifically so stated, but rather “one or more”. All structural and functional equivalents to the elements of the various embodiments described throughout the disclosure that are known or later come to be known to those of ordinary skill in the art are intended to be encompassed by the elements of the claims. Moreover, nothing disclosed herein is intended to be dedicated to the public regardless of whether such disclosure is explicitly recited in the claims.

1. A system for handling blowdown gas evacuated from an upstream segment of pipeline, said system comprising:
a. one or more compressor units for receiving blowdown gas for recompression;
b. an incinerator unit for receiving blowdown gas from any one or more of: the upstream segment of pipeline, the one or more compressor units or one or more pressure vessels;
c. a flow control diverter valve for directing blowdown gas from the segment of pipeline or from the one or more compressor units to any one or more of: the incinerator unit, the one or more pressure vessels and a downstream section of the pipeline downstream from the upstream segment of pipeline;
d. interconnected piping connecting between any one or more of the upstream segment of pipeline, the one or more compressor units, the incinerator unit, the one or more pressure vessels and the flow control valve;
e. one or more sensors associated with each of the one or more compressor units, the one or more incinerator units, the one or more pressure vessels and the interconnected piping to collect operational data about each of the one or more compressor units, the one or more incinerator units, the one or more pressure vessels and the interconnected piping and gas data about the blowdown gas;
f. a processor in communication with the one or more sensors for receiving the operational data about each of the one or more compressor units, the one or more incinerator units, the one or more pressure vessels and the interconnected piping and the gas data, said processor comprising a memory wherein instructions stored in the memory are executable by the processor for determining, from the operational data and the gas data, one or more switchover pressures at which blowdown gas should be re-directed from a recompression operation to an incineration operation; and
g. a control system in communication with the processor and with the flow control diverter valve for actuating the flow control diverter valve to re-direct blowdown gas from a recompression operation to an incineration operation at the switchover pressure.

2. The system of claim 1, wherein the processor is programmable with operational various constraints including evacuation time limits, emission limits, and blowdown gas recovery requirements.

3. The system of claim 1, wherein operational data and gas data collected by the sensors comprises pressure decay in the upstream segment of the pipeline to be blown down, changes in blowdown gas flowrate and mass of blowdown gas out of the upstream pipeline segment, emissions amounts and rates, compressor working rates and mass and volume of gas being directed to each of the incinerator unit, one or more pressure vessels or the downstream section of the pipeline.

4. The system of claim 1 wherein the processor is programmable with blowdown event goals, including blowdown time limits, emissions limits and gas recovering and repurposing goals.

5. The system of claim 1 wherein the processor further determines optimum blowdown gas distribution and operational duration of recompression vs. incineration vs. venting operations.

6. The system of claim 1 wherein the processor is located either in a computing device on-site of the system or in a central location that is remote from but communicable with the system.

7. The system of claim 6 wherein the processor is located in a central location and communicates with the system over the internet, wherein the system further comprises a receiver for receiving information from the central processor.

8. The system of claim 1, wherein gas data, operational data and determined switchover pressures are accessible at the skid system or via a remote portal and viewable on such devices including personal computers, laptops, tablets, and smart phones.

9. The system of claim 1, wherein the system comprises three compressor units each configured to receive gas from the flow control diverter valve and each associated with one of the incinerator unit, the one or more pressure vessels or the downstream segment of the pipeline, to supply recompressed gas thereto.

10. The system of claim 1, further comprising a secondary valve for directing gas from the upstream segment of the pipeline either directly to the incinerator unit or to the incinerator unit via one or more of the one or more compressors or the one or more pressure vessels.

11. The system of claim 1, wherein the flow control diverter valve is configured to direct blowdown gas to any one of a first compressor unit that supplies recompressed gas to a first pressure vessel, a second compressor that supplies recompressed gas to a second pressure vessel, or directly to the second pressure vessel, and wherein the second pressure vessel is configured to further supply recompressed gas to the incinerator unit.

12. A method for handling blowdown gas evacuated from an upstream segment of a pipeline, said method comprising the steps of:
a. receiving blowdown gas from the upstream segment of pipeline to a compressor unit;
b. recompressing the blowdown gas to increase blowdown gas pressure;
c. receiving the recompressed blowdown gas in any one or more of: an incinerator unit; a pressure vessel or a downstream section of the pipeline downstream from the upstream segment; and
d. receiving at a processor, gas data regarding the blowdown gas from the segment of pipeline and operational data on the operation on each of the compressor unit, the incinerator unit, and the pressure vessel; wherein the processor performs the steps of:
i. determining by one or more algorithms stored in the processor, a switchover pressure at which blowdown gas should be re-directed from a recompression operation to an incineration operation; and
ii. directing, by communication from the processor, a flow control diverter valve to re-direct blowdown gas from a recompression operation to an incineration operation at the switchover pressure.

13. The method of claim 12, wherein the switchover pressure is determined at least in part from simulation data from simulations of blowdown events to solely venting, solely recompression and solely incineration that are solved iteratively to determine factors comprising volume flow rate of blowdown gas, mass flow rate of blowdown gas, pressure gradient of the blowdown gas, and compression power input required.

14. The method of claim 12, further comprising, as pressure of the blowdown gas decreases:
a. calculating an increased time required for incineration and/or recompression operation;
b. comparing the increased time for incineration and/or recompression to the quantity of emissions reduced by either incinerating or recompressing a decreased amount of blowdown gas as pressure decreases; and
c. determining from emissions reductions data, time required for incineration or recompression data, time restraints or goals of the blowdown operation, a switchover pressure to switch from recompression and/or incineration to venting.
